(19) United States
(12) Patent Application Publication
(10) Pub. No.: US 2025/0101319 A1
(43) Pub. Date: Mar. 27, 2025

(54) PROCESS AND APPARATUS FOR CHEMICALLY TREATING A CARBON-CONTAINING FEEDSTOCK

(71) Applicant: BRASKEM AMERICA, INC., Philadelphia, PA (US)

(72) Inventors: Vibin Vargheese, Pittsburgh, PA (US); Nicholas Wang, Pittsburgh, PA (US); Matthew Feeney, Pittsburgh, PA (US); Ishant Khurana, Pittsburgh, PA (US); Jan Kalfus, Pittsburgh, PA (US); Scott Mitchell, Pittsburgh, PA (US); Richard Opfer, Pittsburgh, PA (US)

(21) Appl. No.: 18/897,206

(22) Filed: Sep. 26, 2024

Related U.S. Application Data
(60) Provisional application No. 63/585,775, filed on Sep. 27, 2023.

(51) Int. Cl. C10G 47/14; B01J 8/02; B01J 21/04; B01J 23/883; B01J 29/16

(52) U.S. Cl. CPC C10G 47/14; B01J 8/0278; B01J 21/04; B01J 23/883; B01J 29/166; C10G 2300/1003

(57) ABSTRACT

This invention relates to a process for chemically treating a carbon-containing feedstock (e.g., a polymer-based feedstock), comprising contacting (e.g., by a hydrocracking reaction) the carbon-containing feedstock and a hydrogen stream in the presence of at least one hydrocracking catalyst to produce an alkane-containing product stream. The hydrocracking catalyst comprises at least one transition metal or transition metal sulfide supported on an oxide-containing support. This invention also relates to an alkane-containing mixture obtained by the process described herein and a system/apparatus for carrying out the process described herein.

### PRIORITY CLAIM

This application claims priority to U.S. Provisional Patent Application No. 63/585,775, filed Sep. 27, 2023, which is incorporated herein by reference in its entirety.

### FIELD OF THE INVENTION

This invention generally relates to a process and system for chemically treating a carbon-containing feedstock.

### BACKGROUND OF THE INVENTION

Plastic waste is a diverse feedstock which may contain several different types of polymers, fillers, stabilizing agents, and/or contaminants. The inconsistent quality of the feedstock provides a technical challenge in the conversion of plastics to chemicals.

The current technologies in conversion of plastics to chemicals typically employ a multi-stage process. The first stage involves thermal cracking (pyrolysis) of waste plastic to pyrolysis oil and gas, which may be carried out with or without a catalyst. These products, however, have a significant weight fraction of unsaturated hydrocarbons. Thus, a second stage is typically necessary for hydrogenating the unsaturated hydrocarbons to saturated hydrocarbons, under high hydrogen pressure over a hydrogenation catalyst.

However, the conventional process generates large amounts of unsaturated hydrocarbons which may not been completely converted to saturated hydrocarbons. Additionally, multi-stage process is cumbersome and requires additional pyrolysis units.

There thus remains a need in the art for a process and system to more efficiently crack the polymer feedstock, while increasing the yield and quality of the recovered liquid hydrocarbon product suitable for further cracking.

### SUMMARY OF THE INVENTION

One aspect of the invention relates to a process for chemically treating a carbon-containing feedstock. The process comprises contacting the carbon-containing feedstock and a hydrogen stream in the presence of at least one hydrocracking catalyst to produce an alkane-containing product stream. The hydrocracking catalyst comprises at least one transition metal or transition metal sulfide supported on an oxide-containing support.

Another aspect of the invention relates to a process for depolymerizing a polymer-based feedstock. The process comprises reacting a polymer-based feedstock with a hydrogen stream in the presence of a hydrocracking catalyst, in a one-step, hydrocracking reaction, to depolymerize the polymer-based feedstock and form an alkane-containing product stream. The hydrocracking catalyst comprises at least one transition metal or transition metal sulfide supported on an oxide-containing support.

Another aspect of the invention relates to an alkane-containing mixture obtained by the process described herein for chemically treating a carbon-containing feedstock or for depolymerizing a polymer-based feedstock.

Another aspect of the invention relates to a system/apparatus for chemically treating a carbon-containing feedstock. The system comprises a reactor receiving the carbon-containing feedstock, a hydrogen stream, and at least one hydrocracking catalyst, wherein the reactor is configured to convert the carbon-containing feedstock into an alkane-containing product stream. The hydrocracking catalyst comprises at least one transition metal or transition metal sulfide supported on an oxide-containing support.

Another aspect of the invention relates to a system for depolymerizing a polymer-based feedstock. The system comprises a reactor receiving the polymer-based feedstock, a hydrogen stream, and at least one hydrocracking catalyst, wherein, in the reactor, the polymer-based feedstock reacts with the hydrogen stream in the presence of a hydrocracking catalyst, in a one-step, hydrocracking reaction, to depolymerize the polymer-based feedstock and form an alkane-containing product stream. The hydrocracking catalyst comprises at least one transition metal or transition metal sulfide supported on an oxide-containing support.

Another aspect relates to a method for controlling a carbon chain length distribution of a product stream obtained from depolymerizing a polymer-based feedstock. The method comprises the steps of:
selecting a molar ratio between aluminum oxide and silicon oxide of a catalytic support comprising a mixture of aluminum oxide and silicon oxide;
providing a catalyst comprising at least one transition metal or transition metal sulfide supported on the catalytic support having the selected molar ratio between aluminum oxide and silicon oxide;
selecting a temperature in the range of 200 to 500° C. to carry out the depolymerization reaction; and
reacting the polymer-based feedstock and a hydrogen stream in the presence of the catalyst at the selected temperature to generate an alkane-containing product stream, having controlled alkane carbon chain distribution.

Another aspect relates to a method for selectively converting a polymer-based feedstock to a liquid naphtha or naphtha-like product. The method comprises reacting a polymer-based feedstock with a hydrogen stream in the presence of a hydrocracking catalyst, in a one-step, hydrocracking reaction, to depolymerize the polymer-based feedstock and form a liquid naphtha or naphtha-like product containing at least 50% by weight of C₄-C₁₂ hydrocarbons (e.g., C₄-C₁₂ alkanes) and no more than 5% by weight of unsaturated hydrocarbons, based on the total weight of the product. The hydrocracking catalysts are those described herein. Exemplary hydrocracking catalysts are those comprising at least one transition metal or transition metal sulfide supported on a catalytic support comprising an aluminum oxide or a mixture of silicon oxide and aluminum oxide at a molar ratio ranging from 5 to 80. The reaction conditions are those described herein. Exemplary reaction temperatures range from about 300-450° C. and exemplary hydrogen pressures range from about 5 to 100 bar.

Another aspect of the invention relates to a method comprising utilizing a hydrocracking catalyst comprising at least one transition metal or transition metal sulfide supported on an oxide-containing support for converting a carbon-containing feedstock into an alkane-containing product stream.

Another aspect of the invention relates to a method comprising utilizing a hydrocracking catalyst comprising at least one transition metal or transition metal sulfide supported on an oxide-containing support for depolymerizing a polymer-based feedstock into an alkane-containing product stream.

Additional aspects, advantages and features of the invention are set forth in this specification, and in part will become apparent to those skilled in the art on examination of the following or may be learned by practice of the invention. The inventions disclosed in this application are not limited to any particular set of or combination of aspects, advantages, and features. It is contemplated that various combinations of the stated aspects, advantages and features make up the inventions disclosed in this application.

### BRIEF DESCRIPTION OF DRAWINGS

FIGS. 1A-1B are graphs showing the yields of various components contained in the product resulted from the liquefaction reaction of HDPE feedstock without adding a catalyst. A shows the effect of varying the reaction temperature at a reaction time of 1 hour. B shows the effect of varying the reaction time at a reaction temperature of 430° C. For each reaction temperature or reaction time datapoint, the bars showing four components, from left to right, represent gas (C₁-C₃), naphtha (C₄-C₁₂), kerosene (C₁₃-C₂₀), and C₂₀+, respectively. The solid circle • for each bar in each bar graph represents the mass balance.

FIGS. 2A-2C are graphs showing the yields of various components contained in the product resulted from the liquefaction reaction of HDPE feedstock in the presence of an exemplary NiMo/H—USY catalyst at a relatively low, medium, and high acidity. A shows the results of a low-acidity NiMo/H—USY-60 catalyst. B shows the results of a medium-acidity NiMo/H—USY-30 catalyst. C shows the results of a high-acidity NiMo/H—USY-5 catalyst. For each reaction temperature or reaction time datapoint, the bars showing four components, from left to right, represent gas (C₁-C₃), naphtha (C₄-C₁₂), kerosene (C₁₃-C₂₀), and C₂₀₊, respectively. The solid circle • for each bar in each bar graph represents the mass balance.

FIGS. 3A-3B show the composition of the naphtha product obtained from the liquefaction reaction of HDPE feedstock (A), compared to the composition of the naphtha product used in a commercial refinery (B).

FIGS. 4A-4B are graphs showing the compositional analysis of the product resulted from the liquefaction reaction of HDPE feedstock at 440° C. for 2 hours in the presence of NiMo/γ-Al₂O₃ catalyst, compared to the compositional analysis of the product resulted from two control experiments under the same reaction conditions, but in the absence of a catalyst, or in the presence of the weakly acidic support γ-Al₂O₃ support. A shows the compositional analysis of the naphtha product stream (C₄-C₁₂) using GC-MS. B shows the yields of various components (gas (C₁-C₃), naphtha (C₄-C₁₂), kerosene (C₁₃-C₂₀), and C₂₀+) contained in the product using GC. The solid circle • for each bar represents the mass balance.

FIG. 5 is a graph showing the compositional analysis of the product resulted from the liquefaction reaction of HDPE feedstock at 340° C. for 1 hour in the presence of NiMo/H—USY-60 catalyst, at different hydrogen partial pressures. It shows the yields of various components (gas (C₁-C₃), naphtha (C₄-C₁₂), kerosene (C₁₃-C₂₀), and C₂₀+) contained in the product using GC. The solid circle • for each bar represents the mass balance.

FIG. 6 is a graph showing the compositional analysis of the product resulted from the liquefaction reaction of HDPE feedstock at 350° C. for 1 hour in the presence of NiMo/H—USY-60 catalyst, at different total pressures. It shows the yields of various components (gas (C₁-C₃), naphtha (C₄-C₁₂), kerosene (C₁₃-C₂₀), and C₂₀+) contained in the product using GC. The solid circle • for each bar represents the mass balance.

### DETAILED DESCRIPTION OF THE INVENTION

The disclosure provides a novel process and apparatus/system for converting a carbon-containing feedstock (such as a polymer-based feedstock) into an alkane-containing product stream. For instance, the novel process involves a plastic liquefaction using a single-stage (also a one-pot process) hydrocracking unit, for cracking and hydrotreating waste plastic into a high-quality liquid product (e.g., containing high yield of saturated naphtha). The inventive process and apparatus/system provide control over of the yield and quality of the produced liquid products (e.g., naphtha or naphtha-like product). The inventive process and apparatus/system do not employ a pyrolysis unit, yet can provide high yields and high quality of circular naphtha from waste plastics, without producing detectable levels of unsaturated hydrocarbons (which are typically contained in the products produced by processes involving pyrolysis). The resulting naphtha or naphtha-like product with significantly improved yield and purity can be fed into a chemical cracking furnace to further produce value-adding chemicals, such as monomers for polymer productions.

One aspect of the invention relates to a process for chemically treating a carbon-containing feedstock. The process comprises contacting the carbon-containing feedstock and a hydrogen stream in the presence of at least one hydrocracking catalyst to produce an alkane-containing product stream. The hydrocracking catalyst comprises at least one transition metal or transition metal sulfide supported on an oxide-containing support.

The contacting step can be a reacting step, in which a hydrocracking reaction occurs between the feedstock and hydrogen.

Another aspect of the invention relates to a process for depolymerizing a polymer-based feedstock. The process comprises reacting a polymer-based feedstock with a hydrogen stream in the presence of a hydrocracking catalyst, in a one-step, hydrocracking reaction, to depolymerize the polymer-based feedstock and form an alkane-containing product stream. The hydrocracking catalyst comprises at least one transition metal or transition metal sulfide supported on an oxide-containing support.

### The Feedstock

The feedstock used in the processes described herein can be any carbon-containing feedstock (e.g., a polymer-based feedstock).

The carbon-containing feedstock (e.g., a polymer-based feedstock) may be a petroleum-based resin (e.g., petroleum-based virgin resin), bio-based resin, recycled resin, or combinations thereof. For instance, the carbon-containing feedstock (e.g., a polymer-based feedstock) may comprise a virgin resin, a recycled resin, or combinations thereof. In some embodiments, the carbon-containing feedstock (e.g., a polymer-based feedstock) may comprise a combination of a recycled resin, biobased resin, and optionally a petroleum-based resin such that the resulting composition achieves low or neutral carbon emission (or even a carbon uptake).

The recycled resin may comprise a post-consumer resin (PCR), a post-industrial resin (PIR), or combinations thereof, including regrind, scraps and defective articles. PCR refers to resins that are recycled after consumer use, whereas PIR refers to resins that are recycled from industrial materials and/or processes (for example, cuttings of materials used in making other articles). The recycled resin may include resins having been used in rigid applications (such as from blow molded articles, including 3D-shaped articles) as well as in flexible applications (such as from films). The recycled resin may be of any color, including, but not limited to, black, white, or grey, depending on the color used in the ultimate article. The form of the recycled resin is not particularly limited, and may be in pellets, flakes, and agglomerated films. In some embodiments, the recycled resin used is a PCR or PIR that comprises one or more polyolefins. In some embodiments, the recycled resin is a recycled material according to ISO 14021. In some embodiments, the carbon-containing feedstock (e.g., a polymer-based feedstock) is a post-consumer resin (PCR) or a post-industrial resin (PIR).

In some embodiments, the carbon-containing feedstock is a polymer-based feedstock. Exemplary polymer-based feedstocks are polyolefins, polyvinyl chlorides, polyesters, polystyrenes, polyacrylates, polymethacrylates, polyamides, polycarbonates, and mixtures thereof.

Suitable polyolefins include those prepared from linear, branched, or cyclic olefin monomers having 2 to 20 carbon atoms, 2 to 16 carbon atoms, or 2 to 12 carbon atoms. Exemplary olefin monomers are α-olefins including but not limited to ethylene, propylene, 1-butene, 2-butene, 1-pentene, 3-methyl-1-butene, 1-hexene, 4-methyl-1-pentene, 3-methyl-1-pentene, 4,6-dimethyl-1-heptene, 1-octene, 1-nonene, 1-decene, 1-undecene, 1-dodecene, 1-tetradecene, 1-hexadecene, 1-octadecene, 1-eicocene, vinylcyclohexane, styrene, tetracyclododecene, norbornene, 5-ethylidene-2-norbornene (ENB), and combinations thereof. These olefins may each contain a heteroatom such as an oxygen, nitrogen, or silicon atom.

Exemplary polyolefins include a propylene-based polymer, an ethylene-based polymers, an ethylene-vinyl ester polymer, or a C₄-C₁₂ olefin-based polymer. The ethylene-based polymer contained can be low-density polyethylene (LDPE), linear low-density polyethylene (LLDPE), high-density polyethylene (HDPE), medium-density polyethylene (MDPE), polyethylene wax, ultrahigh-molecular weight polyethylene, ethylene copolymer, and combinations thereof.

Suitable polyolefins also include a copolymer prepared from two or more olefin comonomers, which include polyene comonomers (having 3 to 20 carbon atoms including but not limited to butadiene (e.g., 1,3-butadiene), isoprene, pentadiene (e.g., 1,3-pentadiene; 1,4-pentadiene; 3-methyl-1,4-pentadiene; 3,3-dimethyl-1,4-pentadiene), dimethylbutadiene, dimethylpentadiene, hexadiene (e.g., 1,3-hexadiene; 1,4-hexadiene; 1,5-hexadiene; 4-methyl-1,4-hexadiene; 5-methyl-1,4-hexadiene; 3-methyl-1,5-hexadiene; 3,4-dimethyl-1,5-hexadiene), heptadiene (e.g., 1,3-heptadiene; 1,4-heptadiene; 1,5-heptadiene; 1,6-heptadiene; 6-methyl-1,5-heptadiene), methylhexadiene, dimethylhexadiene, octadiene (e.g., 1,3-octadiene; 1,4-octadiene; 1,5-octadiene; 1,6-octadiene; 1,7-octadiene; 7-methyl-1,6-octadiene; 3,7-dimethyl-1,6-octadiene; 5,7-dimethyl-1,6-octadiene), nonadienes (e.g., 1,8-nonadiene), decadiene (e.g., 1,9-decadiene), undecadiene (e.g., 1,10-undecadiene), dicyclopentadienes, octatriene (e.g., 3,7,11-trimethyl-1,6,10 octatriene), 4-vinyl cyclohexene, dicyclopentadiene, vinyl comonomers (including but not limited to acrylonitrile and acrylamide, and their derivatives), and vinylaromatic comonomers (including but not limited to styrene and its derivatives, such as α-methylstyrene); any of which may each contain a heteroatom such as an oxygen, nitrogen, or silicon atom.

Suitable styrene-based polymers include but are not limited to polymers prepared from monomers such as styrene, α-methylstyrene, p-methylstyrene, vinylxylene, vinylnaphthalene, and mixtures thereof; and optionally a diene comonomer such as butadiene, isoprene, pentadiene, and mixtures thereof.

Suitable polyesters include but are not limited to polyethylene terephthalate, polybutylene terephthalate, polyethylene naphthalate, polybutylene naphthalate, polyethylenc isophthalate, polycarbonate, copolymerization of polyesters with ethylene terephthalate as a main repeating unit (such as polyethylene (terephthalate/isophthalate), polyethylene (terephthalate/isophthalate), polyethylene (terephthalate/adipate), polyethylene (terephthalate/sodium sulfoisophthalate), polyethylene (terephthalate/sodium isophthalate), polyethylene (terephthalate/phenyl-dicarboxylate) and polyethylene (terephthalate/decane dicarboxylate)), and copolymerization of polyesters with a butylene terephthalate as a main repeating unit (such as polybutylene (terephthalate/isophthalate)), polybutylene (terephthalate/adipate), polybutylene (terephthalate/sebacate), polybutylene (terephthalate/decane dicarboxylate)).

Suitable polyamides include aliphatic polyamides such as nylon-6, nylon-66, nylon-10, nylon-12 and nylon-46; and aromatic polyamides produced from aromatic dicarboxylic acid and aliphatic diamine.

The carbon-containing feedstock (e.g., a polymer-based feedstock) may be plastic materials containing, but are not limited to, ABS, polyacetal, acrylic, ionomer, polyamide in general, Nylon 6, Nylon 6/6, Nylon 6/9, Nylon 6/10, Nylon 6/12, Nylon 11, Nylon 12, polycarbonate, polyester (PBT), polyester (PET), polyether ether ketone, polyethylene, polyolefin in general, polyphenylene ether, polyphenylene sulfide, polypropylene, polystyrene, polysulfone, polyurethane, SAN and thermoplastic elastomer. In some embodiments, the carbon-containing feedstock contain intermediate thermoplastics, such as polymethyl methacrylate, acrylonitrile-butadiene-styrene, acrylonitrile/acrylate/styrene, acrylonitrile/ethylene-propylene-diene monomer (EPDM)/styrene, styrene/maleic anhydride copolymers and rubber blends, cellulose-acetate-butyral, thermoplastic olefin elastomer, and the like,

### The Hydrocracking Reaction

### The One-Step Reaction

The reaction for converting the carbon-containing feedstock (e.g., a polymer-based feedstock) to an alkane-containing product stream is a single-step, hydrocracking reaction (or liquefaction reaction). In some embodiments, the process is a one-pot process.

In some embodiment, the process does not involve pyrolysis of the polymer-based feedstock. The process does not involve a conventional two-step process that involves both thermal cracking (pyrolysis) that produces large amounts of unsaturated hydrocarbons and hydrogenation to convert unsaturated hydrocarbons to saturated hydrocarbons. Rather, the reaction herein employs a single-stage, hydrocracking unit, i.e., the cracking and hydrotreating of the carbon-containing feedstock (e.g., a polymer-based feedstock) are carried out in one-step. As indicated in the Examples, such as Example C, the one-step hydrocracking reaction described herein can produce an alkane-containing product stream with a high yield and a high quality (i.e., containing minimal amounts of unsaturated hydrocarbon such as alkenes and/or aromatics).

### The Hydrocracking Catalyst

The one-step, hydrocracking reaction employs a hydrocracking catalyst comprising at least one transition metal or transition metal sulfide, supported on an oxide-containing support.

The metal of the at least one transition metal or transition metal sulfide is typically a Group VI to Group X metal of the periodic table. The metal can be a noble metal (palladium or platinum) or non-noble metal of group VI-A (molybdenum or tungsten) and group VIII-A (cobalt or nickel) of the periodic table. For instance, the metal in the hydrocracking catalyst may be Mo, W, Fe, Co, Ir, Ni, Pd, Pt, and combinations thereof.

In some embodiments, the hydrocracking catalyst comprises two or more transition metals, transition metal sulfides, and combinations thereof, supported on the oxide-containing support. The catalyst may be a blend of two or more different materials within the same type (e.g., two or more different transition metals) or two or more different materials with different types (e.g., one transition metal and one transition metal sulfide). These transition metals or transition metal sulfides are desirable to the hydrocracking reaction, as they provide reaction sites for hydrogen. This significance is illustrated in the Examples, e.g., in Example C, showing that under the same reaction conditions, the reactions in the presence of the oxide-containing support, without transition metals or transition metal sulfides thus without a reaction site for hydrogen, produced a product stream with significantly less C₁-C₂₀ hydrocarbons than the reactions in the presence of the hydrocracking catalyst described herein.

In some embodiments, the at least one transition metal or transition metal sulfide is Pt, Pd, Ir, Ni, Fe, Mo, W, Co, NiMo, CoMo, NiW, NiMOSx, NiWSx or FeSx.

In some embodiments, the hydrocracking catalyst is a transition metal sulfide, such as NiMoSx, NiWSx or FeSx.

In some embodiments, the hydrocracking catalyst is bimetallic comprising two different types of transition metal. In one embodiment, the hydrocracking catalyst is bimetallic NiMo. In one embodiment, the hydrocracking catalyst is bimetallic CoMo.

The hydrocracking catalyst disclosed herein has an oxide-containing support with transition metal or transition metal sulfide impregnated over it. The hydrocracking catalyst desires an acidic support with acidic sites to catalyze the hydrocracking reaction. The oxide-containing support may comprise aluminum oxide, silicon oxide, aluminosilicate, or combinations thereof. Typically, the oxide-containing support is an amorphous oxide such as aluminum oxide (e.g., γ-Al₂O₃); aluminosilicates, for instance, in the form of zeolites; or a mixture of silicon oxide and aluminum oxide.

In some embodiments, the oxide-containing support is aluminum oxide. In one embodiment, γ—Al₂O₃ is used as the oxide-containing support.

In some embodiments, the oxide-containing support is silicon oxide.

In some embodiments, the oxide-containing support is aluminosilicate, for instance, in the form of zeolites.

In some embodiments, the oxide-containing support is a zeolite. A zeolite is a microporous, crystalline aluminosilicate material mainly consisting of silicon, aluminum, and oxygen, typically having the general formula M″+I/n (AlO₂)⁻(SiO₂)ₓ·yH₂O, where M″+I/n is either a metal ion or H⁺, x is Si/Al molar ratio (or SiO₂/AlO₂ molar ratio) and is greater than 1, and y is the number of water molecules in the formula unit. Any types of zeolites well known to one skilled in the art are suitable herein as support for the transition metal or transition metal sulfide in the hydrocracking catalyst. Exemplary types of zeolites are FAU (e.g., Zeolite X, Zeolite Y, and USY), BEA, MOR, MFI, and FER types. Typical support for the transition metal or transition metal sulfide in the hydrocracking catalyst is an acidic support, i.e., M is H⁺. In one embodiment, H—USY is used as the oxide-containing support.

In some embodiments, the oxide-containing support contains a mixture of silicon oxide and aluminum oxide, having a molar ratio of silicon oxide to aluminum oxide (i.e., x, SiO₂/AlO₂ molar ratio) ranging from 1 to 99, for instance from 5 to 80, from 5 to 70, from 5 to 60, or from 30 to 60. Adjusting the molar ratio of silicon oxide to aluminum oxide can adjust the acidity of the support, thus affecting the percentages of various hydrocarbon components having various carbon chain length in the product stream. As shown in Example C below, changing the acidity of the oxide-containing support can change the product distribution of various components obtained in the final product. In some embodiments, a low acidity (e.g., molar ratio of silicon oxide to aluminum oxide of 30 or higher, e.g., 40 or higher, 50 or higher, or 60 or higher) can promote the production of a high-yield and high purity naphtha product (with a percentage of naphtha at 85% or higher, 90% or higher, or 95% or higher).

In some embodiments, the hydrocracking catalyst comprises one or more of Pt, Pd, Ir, Ni, Fe, Mo, W, Co, NiMo, CoMo, NiW, NiMoSx, NiWSx, and FeSx, supported on an aluminum oxide support (e.g., γ-Al₂O₃).

In some embodiments, the hydrocracking catalyst comprises one or more of Pt, Pd, Ir, Ni, Fc, Mo, W, Co, NiMo, CoMo, NiW, NiMOSx, NiWSx, and FeSx, supported on a silicon oxide support.

In some embodiments, the hydrocracking catalyst comprises one or more of Pt, Pd, Ir, Ni, Fe, Mo, W, Co, NiMo, CoMo, NiW, NiMoSx, NiWSx, and FeSx, supported on an aluminosilicate support (e.g., a zeolite, such as an acidic zeolite, e.g., H—USY).

In some embodiments, the hydrocracking catalyst may be prepared using a catalyst precursor comprising a water-soluble salt of the metal, e.g., nitrate, sulfate, acetate, chloride, ammonium, or a mixture thereof. The catalyst supported may be calcined at an elevated temperature. The metal precursor may be dissolved in an aqueous solution and impregnate the calcined support followed by drying, thereby forming the hydrocracking catalyst. When two or more catalyst precursors are used, the catalyst precursor may sequentially impregnate the calcined support or may simultaneously impregnate the calcined support. An exemplary embodiment of synthesis of hydrocracking catalyst is shown in Example A below.

### The Reaction Conditions and Reaction Products

The hydrocracking reaction is carried out in the presence of hydrogen. Hydrogen is provided by a hydrogen stream, which may be a gas of pure hydrogen, or a mixture containing hydrogen and other gases such as CO₂, CO, water, etc. The hydrogen stream may be fed into the reactor alone or may be fed to the reactor along with the carbon-containing feedstock (e.g., a polymer-based feedstock). Hydrogen is essential for the catalytic cracking of the carbon-containing feedstock (e.g., a polymer-based feedstock) particularly at low reaction temperatures. This is illustrated in the Examples, e.g., Example C, showing that under the same reaction conditions, the reaction in the presence of He, without hydrogen, produced a product stream with significantly less C₁-C₂₀ hydrocarbons than the reactions in the presence of hydrogen.

The hydrocracking reaction is typically performed at a hydrogen pressure ranging from about 1 bar to about 200 bar. For instance, the reaction hydrogen pressure may range from about 5 bar to about 100 bar, from about 5 bar to about 90 bar, from about 5 bar to about 80 bar, from about 5 bar to about 70 bar, from about 5 bar to about 60 bar, from about 10 bar to about 200 bar, from about 10 bar to about 100 bar, from about 10 bar to about 90 bar, from about 10 bar to about 80 bar, from about 10 bar to about 70 bar, from about 10 bar to about 60 bar, from about 20 bar to about 100 bar, from about 20 bar to 90 bar, from about 20 bar to 80 bar, from about 20 bar to about 70 bar, from about 20 bar to about 60 bar, from about 30 bar to about 100 bar, from about 30 bar to about 90 bar, from about 30 bar to about 80 bar, from about 30 bar to about 70 bar, from about 30 bar to about 60 bar, about 40 bar to about 100 bar, from about 40 bar to about 90 bar, from 40 bar to 80 bar, from 40 bar to 70 bar, from 40 bar to 60 bar, or from about 45 bar to about 55 bar. In one embodiment, the reaction hydrogen pressure is 50 bar.

The hydrocracking reaction is typically performed at moderate temperatures, ranging from about 200° C. to 500° C. For instance, the reaction temperature may range from about 280° C. to 470° C., from about 280° C. to about 450° C., from about 280° C. to about 430° C., from about 280° C. to about 410° C., from about 280° C. to about 400° C., from about 280° C. to about 370° C., from about 280° C. to about 340° C., from about 280° C. to about 310° C., from about 300° C. to 470° C., from about 300° C. to about 450° C., from about 300° C. to about 430° C., from about 300° C. to about 410° C., from about 300° C. to about 400° C., from about 300° C. to about 370° C., from about 300° C. to about 340° C., from about 310° C. to 470° C., from about 310° C. to about 450° C., from about 310° C. to about 430° C., from about 310° C. to about 410° C., from about 310° C. to about 400° C., from about 310° C. to about 370° C., from about 310° C. to about 340° C. In one embodiment, the reaction temperature ranges from about 310° C. to about 340° C.

The products obtained from the hydrocracking reaction include saturated hydrocarbons, such as alkanes, and optionally unsaturated hydrocarbons, such as unsaturated acyclic hydrocarbons (e.g., alkenes) and/or aromatics.

The product streams obtained from the hydrocracking reaction include a liquid product stream (primarily C₄-C₂₀ hydrocarbons, e.g., naphtha or naphtha like product, and/or diesel, kerosene or kerosene like product), an optional gas product stream (primarily C₁-C₃ hydrocarbons), and an optional solid product stream (primarily C₂₀+ hydrocarbons).

In some embodiments, the process produces an alkane-containing product stream comprises C₁-C₂₀ hydrocarbons (e.g., C₁-C₂₀ alkanes).

The process described herein more efficiently crack the polymer feedstock, while increasing the yield and quality of the recovered liquid hydrocarbon product suitable for further cracking. The process can have a C₁-C₂₀ hydrocarbon (e.g., C₁-C₂₀ alkane) product yield of at least 50%. For instance, the process can have a C₁-C₂₀ hydrocarbon (e.g., C₁-C₂₀ alkane) product yield of at least 55%, at least 60%, at least 65%, at least 70%, at least 75%, at least 80%, at least 85%, at least 90%, or at least 95%.

By avoiding the pyrolysis reaction and using the hydrocracking catalyst and hydrocracking reaction described herein, the process can produce an alkane-containing product stream containing a reduced amount or minimized amount of unsaturated hydrocarbons. The process can produce an alkane-containing product stream containing no more than 30% by weight of unsaturated hydrocarbons, based on the total weight of the product stream. For instance, the process can produce an alkane-containing product stream containing no more than 25%, no more than 20%, no more than 15%, no more than 10%, no more than 5%, no more than 4%, no more than 3%, no more than 2%, no more than 1%, or no more than 0.5%, by weight, of unsaturated hydrocarbons, based on the total weight of the product stream.

The process can produce an alkane-containing product stream containing no more than 20% by weight of aromatic compounds, based on the total weight of the product stream. For instance, the process can produce an alkane-containing product stream containing no more than 18%, no more than 16%, no more than 15%, no more than 10%, no more than 5%, no more than 4%, no more than 3%, no more than 2%, no more than 1%, or no more than 0.5%, by weight, of aromatic compounds, based on the total weight of the product stream.

The process can produce an alkane-containing product stream containing no more than 10% by weight of unsaturated acyclic hydrocarbons (e.g., alkenes). For instance, the process can produce an alkane-containing product stream containing no more than 8%, no more than 6%, no more than 5%, no more than 4%, no more than 3%, no more than 2%, no more than 1%, or no more than 0.5%, by weight, of unsaturated acyclic hydrocarbons (e.g., alkenes), based on the total weight of the product stream. In some instance, the process can eliminate certain unsaturated acyclic hydrocarbons (e.g., alkenes) to an undetectable level (˜ 0%).

By avoiding the pyrolysis reaction and using the hydrocracking catalyst and hydrocracking reaction described herein, the process can also selectively produce an alkane-containing product stream containing an increased amount of naphtha or naphtha-like product, compared to a process employing a pyrolysis process (having otherwise same conditions), compared to a process that does not employ the hydrocracking reaction as described herein (having otherwise same conditions), and/or compared to a process that does not employ the hydrocracking catalyst as described herein (having otherwise same conditions). “Naphtha” or “naphtha-like” product may include hydrocarbons or mixtures thereof, majority of which having a carbon chain length ranging from C₄ to C₁₄, C₅ to C₁₄, C₄-C₁₂, or C₅-C₁₂. In one embodiment, the naphtha or naphtha-like product contains primarily C₄-C₁₂, hydrocarbons.

One way to further increase selectivity towards naphtha or naphtha-like product (e.g., C₄-C₁₄, C₅ to C₁₄, C₄-C₁₂, or C₅-C₁₂ hydrocarbons) is by adjusting the hydrocracking catalyst, particularly the acidity of the oxide-containing support in the hydrocracking catalyst. For instance, when the oxide-containing support contains a mixture of silicon oxide and aluminum oxide, adjusting the molar ratio of silicon oxide to aluminum oxide to result in a low-acidity support (e.g., a molar ratio of silicon oxide to aluminum oxide of 30 or higher, e.g., 40, 50, 60, or more) can promote the production of a high-yield and high purity naphtha or naphtha-like product (with a percentage of naphtha or naphtha-like product at 70% or higher, 85% or higher, 80% or higher, 85% or higher, 90% or higher, 95% or higher, 96% or higher, or 97% or higher, by weight, based on the total weight of the product stream).

In some embodiments, the process has a selectivity towards naphtha or naphtha-like product (e.g., C₄-C₁₄, C₅ to C₁₄, C₄-C₁₂, or C₅-C₁₂ hydrocarbons) of at least 50%, for instance, at least 55%, at least 60%, at least 65%, at least 70%, at least 75%, at least 80%, at least 85%, at least 90%, at least 95%, at least 96%, at least 97%, at least 99%, at least 99%, or virtually 100%, by weight, based on the total weight of the product stream.

After converting the carbon-containing feedstock (e.g., a polymer-based feedstock) to an alkane-containing product stream, the product stream from the hydrocracking reaction may be further separated into two or more different product streams. The separation may be based on the molecular weight of the components of the product stream from the hydrocracking reaction. Thus, the process may further comprise the step of separating the product stream from the hydrocracking reaction (e.g., the alkane-containing product stream) into two or more different product streams based on the molecular weight of the components of the product stream from the hydrocracking reaction (e.g., the alkane-containing product stream).

In some embodiments, the process may further comprise the step of separating the product stream from the hydrocracking reaction (e.g., the alkane-containing product stream) into two or more different product streams such as a light-component stream (e.g., a gas stream, such as C₁-C₃ product stream or a C₁-C₄ product stream), a naphtha or naphtha-like stream (e.g., a C₄-C₁₂ product stream, C₅-C₁₂ product stream, C₄-C₁₄ product stream, or C₅-C₁₄ product stream), a diesel or kerosene product stream (e.g., a C₁₃-C₁₉ product stream, C₁₃-C₂₀ product stream, C₁₅-C₁₉ product stream, or C₁₅-C₂₀ product stream), and/or a heavy-component stream (e.g., a C₂₀+ product stream such as C₂₀ to C₅₀ product stream). In one embodiment, the diesel or kerosene product stream contains primarily C₁₃-C₂₀, hydrocarbons.

In one embodiment, the different product streams are selected from a C₁-C₃ product stream, a C₄-C₁₂ product stream, a C₁₃-C₂₀ product stream, and a C₂₀₊ product stream.

In some embodiments, the process may further comprises the step of pre-mixing the carbon-containing feedstock (e.g., the polymer-based feedstock) with a solvent medium, prior to the contacting or reacting step. The solvent medium typically is a liquid that can act as a medium to transport the polymer-based feedstock (e.g., a hot, viscous plastic waste) to the reactor.

In some embodiments, the solvent medium comprises a liquid hydrocarbon.

The solvent medium may come from the liquid product stream that is produced and/or separated from the process described herein. For instance, the liquid product stream (e.g., C₄-C₂₀ hydrocarbons), formed from the process described herein and separated from the gas product stream and/or solid product stream as described herein, can be used as the solvent medium to mix with the polymer-based feedstock and transport the polymer-based feedstock to the reactor. As another example, diesel, kerosene or kerosene like product stream (e.g., C₁₃-C₂₀ hydrocarbons), formed from the process described herein and separated from the gas product stream, naphtha or naphtha like product stream, and/or solid product stream as described herein, can be used as the solvent medium to mix with the polymer-based feedstock and transport the polymer-based feedstock to the reactor. Thus, in some embodiments, the solvent medium comprises a liquid product stream (e.g., C₄-C₂₀ hydrocarbons), obtained from the depolymerization reaction. In some embodiments, the solvent medium comprises a diesel, kerosene or kerosene like product stream (e.g., C₁₃-C₂₀ hydrocarbons), obtained from the depolymerization reaction. The solvent medium may come from the liquid product stream. The polymer-based feedstock

Additional aspects of the invention relate to various products or product streams produced from the process described herein.

Thus, one aspect of the invention relates to an alkane-containing mixture obtained from the processes described herein.

In some embodiments, the disclosure provides an alkane-containing mixture obtained from the process for chemically treating a carbon-containing feedstock, said process comprising contacting the carbon-containing feedstock and a hydrogen stream in the presence of at least one hydrocracking catalyst to produce an alkane-containing product stream, wherein the hydrocracking catalyst comprises at least one transition metal or transition metal sulfide supported on an oxide-containing support.

In some embodiments, the disclosure provides an alkane-containing mixture obtained from the process for depolymerizing a polymer-based feedstock, said process comprising reacting a polymer-based feedstock with a hydrogen stream in the presence of a hydrocracking catalyst, in an one-step, hydrocracking reaction, to depolymerize the polymer-based feedstock and form an alkane-containing product stream, wherein the hydrocracking catalyst comprises at least one transition metal or transition metal sulfide supported on an oxide-containing support.

All above descriptions and all embodiments discussed in the above aspects relating to the process for chemically treating a carbon-containing feedstock and the process for depolymerizing a polymer-based feedstock, including various aspects of the feedstock, the hydrogen stream, the hydrocracking catalyst, and the hydrocracking reaction conditions are applicable to this aspect of the invention relating to an alkane-containing mixture obtained from the above processes.

In some embodiments, the alkane-containing mixture obtained from the process described herein contains at least 50%, at least 55%, at least 60%, at least 65%, at least 70%, at least 75%, at least 80%, at least 85%, at least 90%, or at least 95%, by weight, of C₁-C₂₀ hydrocarbons (e.g., C₁-C₂₀ alkanes), based on the total weight of the alkane-containing mixture obtained from the process.

In some embodiments, the alkane-containing mixture obtained from the process described herein contains at least 50%, for instance, at least 55%, at least 60%, at least 65%, at least 70%, at least 75%, at least 80%, at least 85%, at least 90%, at least 95%, at least 96%, at least 97%, at least 99%, at least 99%, or virtually 100%, by weight, of naphtha or naphtha-like product (e.g., C₄-C₁₄, C₅ to C₁₄, C₄-C₁₂, or C₅-C₁₂ hydrocarbons; such as C₄ to C₁₄, C₅ to C₁₄, C₄-C₁₂, or C₅-C₁₂ alkanes) based on the total weight of the alkane-containing mixture obtained from the process. In one embodiment, the naphtha or naphtha-like product contains primarily C₄-C₁₂, hydrocarbons.

In some embodiments, the alkane-containing mixture obtained from the process described herein contains no more than 30%, no more than 25%, no more than 20%, no more than 15%, no more than 10%, no more than 5%, no more than 4%, no more than 3%, no more than 2%, no more than 1%, or no more than 0.5%, by weight, of unsaturated hydrocarbons, based on the total weight of the alkane-containing mixture obtained from the process.

In some embodiments, the alkane-containing mixture obtained from the process described herein contains no more than 20%, no more than 18%, no more than 16%, no more than 15%, no more than 10%, no more than 5%, no more than 4%, no more than 3%, no more than 2%, no more than 1%, or no more than 0.5%, by weight, of aromatic compounds, based on the total weight of the alkane-containing mixture obtained from the process.

In some embodiments, the alkane-containing mixture obtained from the process described herein contains no more than 10%, no more than 8%, no more than 6%, no more than 5%, no more than 4%, no more than 3%, no more than 2%, no more than 1%, no more than 0.5%, or about 0%, by weight, of unsaturated acyclic hydrocarbons (e.g., alkenes), based on the total weight of the alkane-containing mixture obtained from the process.

The alkane-containing mixture obtained from the process described herein can be further cracked to monomers, separated into various monomer components, and/or further fed to a polymerization unit for preparing polymers.

Thus, the process may further comprise a step of converting the alkane-containing mixture (e.g., the naphtha or naphtha-like product containing primarily C₄-C₁₂, hydrocarbons) obtained from the process described herein to produce olefins and/or aromatics. In some embodiments, the optional converting step comprises thermally cracking the alkane-containing mixture (e.g., the naphtha or naphtha-like product containing primarily C₄-C₁₂, hydrocarbons) obtained from the process described herein to obtain one or more lower hydrocarbons. In one embodiment, the alkane-containing mixture (e.g., the naphtha or naphtha-like product containing primarily C₄-C₁₂, hydrocarbons) obtained from the process described herein is mixed with high-pressure steam and fed through a furnace for the cracking step.

In some embodiments, the optional converting step results in a mixture of lower hydrocarbons comprising one or more of ethylene, propylene, butadiene, 1-butene, C₅ crude (i.e., a mixture of C₅ components), C-5 dienes crude (i.e., a mixture of C₅ components rich in cyclopentadiene, piperylene and isoprene), isoprene, and aromatics (e.g., benzene, toluene, xylenes, and cumene). In one embodiment, the optional converting step results in ethylene. In one embodiment, the optional converting step results in propylene. In one embodiment, the optional converting step results in ethylene and propylene.

In some embodiments, the process may further comprise a step for separating the monomer components produced from the converting step described above. In one embodiment, the process may further comprise a step for separating ethylene from other components produced from the converting step described above. In one embodiment, the process may further comprise a step for separating propylene from other components produced from the converting step described above. In one embodiment, the process may further comprise a step for separating ethylene and propylene from other components produced from the converting step described above.

In some embodiments, the process may further comprise a step of polymerizing the monomer components produced from the converting step and/or separating step described above, to form a polyolefin. In one embodiment, the process may further comprise a step of polymerizing ethylene produced from the converting step and/or separating step described above, to form a polyolefin. In one embodiment, the process may further comprise a step of polymerizing propylene produced from the converting step and/or separating step described above, to form a polyolefin. In one embodiment, the process may further comprise a step of polymerizing ethylene and propylene produced from the converting step and/or separating step described above, to form a polyolefin.

### The System for Carrying Out the Process

Another aspect of the invention relates to a system/apparatus for chemically treating a carbon-containing feedstock. The system/apparatus comprises a reactor receiving the carbon-containing feedstock, a hydrogen stream, and at least one hydrocracking catalyst, wherein the reactor is configured to convert the carbon-containing feedstock into an alkane-containing product stream. The hydrocracking catalyst comprises at least one transition metal or transition metal sulfide supported on an oxide-containing support.

Another aspect of the invention relates to a system/apparatus for depolymerizing a polymer-based feedstock. The system/apparatus comprises a reactor receiving the polymer-based feedstock, a hydrogen stream, and at least one hydrocracking catalyst, wherein, in the reactor, the polymer-based feedstock reacts with the hydrogen stream in the presence of a hydrocracking catalyst, in a one-step, hydrocracking reaction, to depolymerize the polymer-based feedstock and form an alkane-containing product stream. The hydrocracking catalyst comprises at least one transition metal or transition metal sulfide supported on an oxide-containing support.

All above descriptions and all embodiments discussed in the above aspects relating to the process for chemically treating a carbon-containing feedstock and the process for depolymerizing a polymer-based feedstock, including various aspects of the feedstock, the hydrogen stream, the hydrocracking catalyst, and the hydrocracking reaction conditions are applicable to these aspects of the invention relating to a system/apparatus for chemically treating a carbon-containing feedstock or a system/apparatus for depolymerizing a polymer-based feedstock.

The hydrocracking reaction can be carried out in a heterogeneous reactor, which can comprise one or more reactor inlets for receiving the carbon-containing feedstock (e.g., polymer-based feedstock), a hydrogen stream, and at least one hydrocracking catalyst; and one or more reactor outlets for outputting the product stream. The heterogeneous reactor can contain a catalytic bed for holding the hydrocracking catalyst. The reactor can further contain a heating module for controlling the reaction temperature. The reactor can further contain a pressure control module for controlling the hydrogen pressure during the reaction.

The reactor may be an ebullated reactor, a slug flow reactor, or a fixed bed reactor. The choice of the reactor for operating the process may be determined by the choice of the hydrocracking catalyst. For instance, a slug flow reactor may be used with a hydrocracking catalyst containing iron; and an ebullated bed reactor or a fixed bed reactor may be used with a hydrocracking catalyst containing Ni, Co, or Mo, e.g., NiMo, or CoMo catalysts.

In some embodiments, two or more different reactors can be used in series, to further hydrogenate/treat the products. For instance, an ebullated bed reactor may be used first for hydrocracking reaction, followed by a fixed bed reactor that can further remove contaminants, such as sulfur, nitrogen, etc.

In some embodiments, the system/apparatus has a single reactor.

The reactor may also be a continuous reaction, e.g., any form of a continuous flow reactor.

As discussed above, the reaction herein employs a single-stage, hydrocracking unit, i.e., the cracking and hydrotreating of the carbon-containing feedstock (e.g., a polymer-based feedstock) are carried out in one-step, and the reaction avoids a pyrolysis reaction. Thus, in some embodiments, the system/apparatus does not include a pyrolysis unit.

The system/apparatus may further comprise a separator downstream the reactor to separate the product stream (e.g., the alkane-containing product stream) into two or more different product streams. The separator may operate to separate different product streams from each other based on the molecular weight of the components of the product stream (e.g., the alkane-containing product stream).

The separator may be a gas separator, a cyclone, a flash vessel, or a distillation column.

The separated light-component stream (such as C₁-C₃ product stream or a C₁-C₄ product stream) can be used as a source of hydrogen stream, by using a steam reformer and shift reactor. The resulting hydrogen stream can be re-directed to the reactor for the hydrocracking reaction.

### Other Methods and Uses

Certain aspects of the invention relate to methods for controlling a carbon chain length distribution of a product stream obtained from depolymerizing a polymer-based feedstock, such as selectively converting the polymer-based feedstock to a liquid naphtha or naphtha-like product.

In some embodiments, the disclosure provides a method for controlling an alkane carbon chain distribution of a product stream obtained from depolymerizing a polymer-based feedstock. The method comprises the steps of:
selecting a molar ratio between aluminum oxide and silicon oxide of a catalytic support comprising a mixture of aluminum oxide and silicon oxide;
providing a catalyst comprising at least one transition metal or transition metal sulfide supported on the catalytic support having the selected molar ratio between aluminum oxide and silicon oxide;
selecting a temperature in the range of 200 to 500° C. to carry out the depolymerization reaction; and
reacting the polymer-based feedstock and a hydrogen stream in the presence of the catalyst at the selected temperature to generate an alkane-containing product stream, having controlled carbon chain length distribution.

As discussed in the above embodiments, the molar ratio of silicon oxide to aluminum oxide in the catalytic support can range from 1 to 99, for instance, from 5 to 80, from 5 to 70, or from 5 to 60. Adjusting the molar ratio of silicon oxide to aluminum oxide can adjust the acidity of the support, thus affecting the percentages of various hydrocarbon components having various carbon chain length in the product stream. Also as discussed in the above embodiments and in various Examples below, selecting a reaction temperature in the range of from about 200 to about 500° C. (preferably from about 300 to about 450° C.) can also affect the percentages of various hydrocarbon components having various carbon chain length in the product stream.

Thus, in some embodiments, the disclosure provides a method for selectively converting a polymer-based feedstock to a liquid naphtha or naphtha-like product. The method comprises reacting a polymer-based feedstock with a hydrogen stream in the presence of a hydrocracking catalyst, in an one-step, hydrocracking reaction, to depolymerize the polymer-based feedstock and form a liquid naphtha or naphtha-like product having at least 50% purity (i.e., containing at least 50% by weight of C₄-C₁₄, C₅ to C₁₄, C₄-C₁₂, or C₅-C₁₂ hydrocarbons) and no more than 30% (e.g., no more than 10%, no more than 5%, no more than 2%, or no more than 1%) by weight of unsaturated hydrocarbons (e.g., unsaturated acyclic hydrocarbons such as alkenes and aromatics), based on the total weight of the product. The hydrocracking catalysts are those described herein. Exemplary hydrocracking catalysts are those comprising at least one transition metal or transition metal sulfide supported on a catalytic support comprising an aluminum oxide or a mixture of silicon oxide and aluminum oxide at a molar ratio ranging from 5 to 80 (e.g., 30 or higher, such as 40, 50, 60, or higher). The reaction conditions are those described herein. Exemplary reaction temperatures range from about 300-450° C. (e.g., from about 280° C. to about 450° C., from about 310° C. to 450° C., from about 310° C. to about 340° C.) and exemplary hydrogen pressures range from about 5 to 100 bar (e.g., from about 20 bar to about 100 bar, from about 45 bar to about 55 bar, or at about 50 bar).

All above descriptions and all embodiments discussed in the above aspects relating to the process for chemically treating a carbon-containing feedstock and the process for depolymerizing a polymer-based feedstock, including various aspects of the feedstock, the hydrogen stream, the hydrocracking catalyst, and the hydrocracking reaction conditions are applicable to these aspects of the invention relating to a method for controlling an alkane carbon chain distribution of a product stream obtained from depolymerizing a polymer-based feedstock, a method for selectively converting a polymer-based feedstock to a liquid naphtha or naphtha-like product.

Another aspect of the invention relates to a method comprising utilizing a hydrocracking catalyst comprising at least one transition metal or transition metal sulfide supported on an oxide-containing support for converting a carbon-containing feedstock into an alkane-containing product stream.

Another aspect of the invention relates to a method comprising utilizing a hydrocracking catalyst comprising at least one transition metal or transition metal sulfide supported on an oxide-containing support for depolymerizing a polymer-based feedstock into an alkane-containing product stream.

In some embodiments, the hydrocracking catalyst is utilized in a one-step process for converting a carbon-containing feedstock into an alkane-containing product stream or a one-step process for depolymerizing a polymer-based feedstock into an alkane-containing product stream.

In some embodiments, the hydrocracking catalyst is utilized in a one-pot process for converting a carbon-containing feedstock into an alkane-containing product stream or a one-pot process for depolymerizing a polymer-based feedstock into an alkane-containing product stream.

All above descriptions and all embodiments discussed in the above aspects relating to the process for chemically treating a carbon-containing feedstock and the process for depolymerizing a polymer-based feedstock, including various aspects of the feedstock, the hydrogen stream, the hydrocracking catalyst, and the hydrocracking reaction conditions are applicable to these aspects of the invention relating to methods for utilizing a hydrocracking catalyst for converting a carbon-containing feedstock into an alkane-containing product stream or for depolymerizing a polymer-based feedstock into an alkane-containing product stream.

Another aspect of the invention relates to a method comprising utilizing the alkane-containing mixture (e.g., the liquid naphtha or naphtha-like product stream) obtained from the processes described herein for a secondary use. That secondary use may be storage (literally) or include any other viable secondary use, such as further processing or immediate use, e.g., for further application such as being directly fed into a chemical cracking furnace to produce value-adding chemicals, such as productions of olefin monomers (e.g., ethylene and/or propylene), and/or further polymerization thereof.

All above descriptions and all embodiments discussed in the above aspects relating to the process for chemically treating a carbon-containing feedstock and the process for depolymerizing a polymer-based feedstock, including various aspects of the feedstock, the hydrogen stream, the hydrocracking catalyst, and the hydrocracking reaction conditions are applicable to these aspects of the invention relating to methods for utilizing a hydrocracking catalyst for converting a carbon-containing feedstock into an alkane-containing product stream or for depolymerizing a polymer-based feedstock into an alkane-containing product stream.

All above descriptions and all embodiments discussed in the above aspects relating to various products or product streams produced from the process described herein, such as the alkane-containing mixture obtained from the processes described herein, are applicable to this aspect of the invention relating to methods of utilizing the alkane-containing mixture obtained from the processes described herein for a secondary use.

### EXAMPLES

The following examples are for illustrative purposes only and are not intended to limit, in any way, the scope of the present invention.

### Example A—Synthesis of an exemplary hydrocracking catalyst

NiMo-supported catalysts were synthesized using the sequential wetness impregnation method. Before synthesis, the H—USY zeolite (Zeolyst International) and γ-Al₂O₃(Sigma Aldrich) catalyst supports were calcined at 550° C. for 4 hours under air. Prior to synthesis, the nickel nitrate and ammonium heptamolybdate metal precursors were dissolved separately in deionized water to make an aqueous solution, based on the desired Ni to Mo weight ratio (0.25) and to a final concentration of Mo of 10% wt (and 2.5% wt. of Ni) in the resulting catalyst. The molybdenum precursor solution was impregnated into the calcined support, followed by overnight drying at 110° C. After drying, the nickel precursor solution was impregnated, followed by overnight drying at 110° C. and calcination at 550° C. for 4 hours under air. For activity testing, the catalyst was reduced under the flow of hydrogen at 450° C. for 4 hours.

### Example B—Baseline Experiments for treating HDPE feedstock

About 400 mg of virgin HDPE (without catalyst) was loaded inside a batch reactor. The reactor was purged with He several times before pressurizing with H₂ to 50 bar. The reactor was immersed in a fluidized sand bath and the reaction was carried out for 1 hour, 2 hours, and 3 hours, respectively, under increased temperatures to 430° C., 450° C., and 470° C., respectively. These experiments served as the initial baseline, control experiments for HDPE liquefaction reaction.

After the reaction, the yield of various components contained in the product and composition % were analyzed with an Agilent 8890 GC instrument, using Supelco Petrocol DH (100 m×250 μm×0.5 μm) and DB-1 column (30 m×320 μm×1 μm). The product quality (compositional analysis) of the naphtha product stream was analyzed with a Gerstel GC-MS instrument, using PoraBOND (100 m×250 μm×0.5 μm), DB-1 (30 m×320 μm×1 μm) and GS-GasPro (30 m×320 μm×0 μm) column.

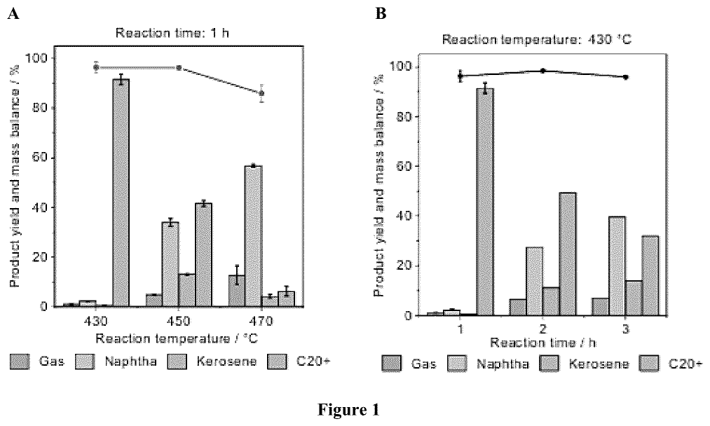

The results are shown in Table 1 and FIGS. 1A and 1B.

TABLE 1
Product yields resulted from HDPE liquefaction without a catalyst

| Reaction conditions | | | Product composition (%) | | | | Mass |
|---|---|---|---|---|---|---|---|
| Temperature/ | Time/ | H₂ Pressure/ | Gas | Naphtha | Kerosene | Solids | balance/ |
| ° C. | hour | bar | (C₁-C₃) | (C₄-C₁₂) | (C₁₃-C₂₀) | C₂₀₊ | % |
| 430 | 1 | 50 | 1.1 | 2.3 | 0.5 | 96.1 | 96.3 |
| 430 | 2 | 50 | 6.9 | 29.1 | 11.7 | 52.3 | 98.4 |
| 430 | 3 | 50 | 7.7 | 42.8 | 15.0 | 34.5 | 95.9 |
| 450 | 1 | 50 | 5.1 | 36.3 | 14.0 | 44.5 | 96.1 |
| 470 | 1 | 50 | 13.8 | 61.4 | 4.5 | 6.8 | 85.8 |

FIGS. 1A and 1B illustrate that, in general, the yields of gas, naphtha, and kerosene increased with the increase in the reaction temperature and reaction time; while the yield of C₂₀+ decreased with the increase in the reaction temperature and reaction time. At the lowest reaction temperature, 430° C., and shortest reaction time, 1 hour, tested, the liquefaction of HDPE resulted in the lowest naphtha yield and highest C₂₀+ (solids) yield. This condition was used as a baseline to show how various exemplified catalysts described in this disclosure can facilitate the reaction.

### Example C—Treating HDPE feedstock with NiMo/H—USY catalyst

The plastic liquefaction experiments were conducted by loading virgin HDPE (400 mg) and NiMo/H—USY catalyst (100 mg) in a batch reactor. The H—USY supports with different SiO₂/Al₂O₃ ratios (H—USY—X zeolite, wherein X is the SiO₂/Al₂O₃ ratios at 5, 30, and 60, respectively) were used to synthesize the NiMo/H—USY catalysts with varying acid strength. The reactor was purged with He several times before pressurizing with H₂ to 50 bar. The reactor was immersed in a fluidized sand bath and the reaction was carried out at different reaction temperatures ranging between 280 to 430° C., for 1 hour.

In this example, the yield of various components contained in the product and composition % were analyzed with an Agilent 8890 GC instrument, using Supelco Petrocol DH (100 m×250 μm×0.5 μm) and DB-1 column (30 m×320 μm×1 μm). The product quality (compositional analysis) of the naphtha product stream was analyzed with a Gerstel GC-MS instrument, using PoraBOND (100 m×250 μm×0.5 μm), DB-1 (30 m×320 μm×1 μm) and GS-GasPro (30 m×320 μm×0 μm) column.

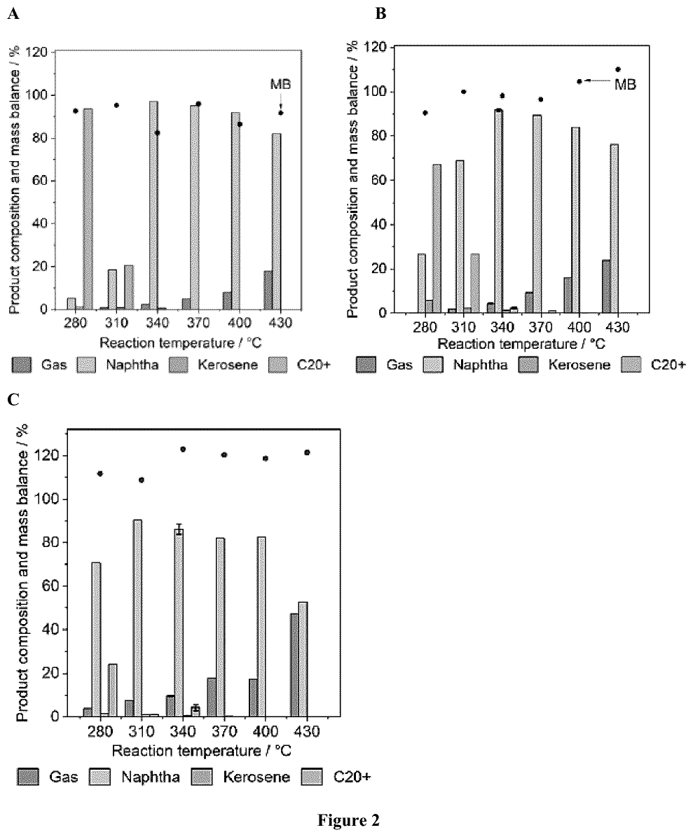

The results of product compositions and mass balance of various components contained in the reaction product using the above reaction conditions are shown in Tables 2-4 and plotted in FIGS. 2A-2B.

TABLE 2
Product yields resulted from HDPE (400 mg) liquefaction
using NiMo/HUSY-60 catalyst (SiO₂/Al₂O₃ = 60) (100 mg)

| Reaction conditions | | | | Product composition/% | | | | Mass |
|---|---|---|---|---|---|---|---|---|
| Temperature/ | Time/ | | Pressure/ | Gas | Naphtha | Kerosene | Solids | balance/ |
| ° C. | hour | Gas | bar | (C₁-C₃) | (C₄-C₁₂) | (C₁₃-C₂₀) | C₂₀₊ | % |
| 280 | 1 | H₂ | 50 | 0.03 | 5.2 | 1.1 | 93.7 | 101.1 |
| 310 | 1 | H₂ | 50 | 0.63 | 18.5 | 0.71 | 20.6 | 104.0 |
| 340 | 1 | H₂ | 50 | 2.3 | 94.3 | 1.5 | 1.9 | 97.5 |
| 340 | 1 | He | 50 | 0.35 | 15.0 | 1.01 | 83.6 | 99.2 |
| 370 | 1 | H₂ | 50 | 4.9 | 95.1 | 0 | 0 | 104.7 |
| 400 | 1 | H₂ | 50 | 8.0 | 92.0 | 0 | 0 | 94.3 |
| 430 | 1 | H₂ | 50 | 17.9 | 82.1 | 0 | 0 | 100.0 |

TABLE 3
Product yields resulted from HDPE (400 mg) liquefaction
using NiMo/HUSY-30 catalyst (SiO₂/Al₂O₃ = 30) (100 mg)

| Reaction conditions | | | | Product composition/% | | | | Mass |
|---|---|---|---|---|---|---|---|---|
| Temperature/ | Time/ | | Pressure/ | Gas | Naphtha | Kerosene | Solids | balance/ |
| ° C. | hour | Gas | bar | (C₁-C₃) | (C₄-C₁₂) | (C₁₃-C₂₀) | C₂₀₊ | % |
| 280 | 1 | H₂ | 50 | 0.34 | 26.6 | 5.9 | 67.1 | 98.6 |
| 310 | 1 | H₂ | 50 | 1.9 | 68.8 | 2.3 | 26.9 | 109.1 |
| 340 | 1 | H₂ | 50 | 4.5 | 91.7 | 1.3 | 2.5 | 107.1 |
| 370 | 1 | H₂ | 50 | 9.3 | 89.4 | 0.27 | 1.1 | 105.3 |
| 400 | 1 | H₂ | 50 | 15.9 | 84.0 | 0.0 | 0.0 | 114.0 |
| 430 | 1 | H₂ | 50 | 23.8 | 76.2 | 0.0 | 0.0 | 120.2 |

TABLE 4
Product yields resulted from HDPE (400 mg) liquefaction
using NiMo/HUSY-5 catalyst (SiO₂/Al₂O₃ = 5) (100 mg)

| Reaction conditions | | | | Product composition/% | | | | Mass |
|---|---|---|---|---|---|---|---|---|
| Temperature/ | Time/ | | Pressure/ | Gas | Naphtha | Kerosene | Solids | balance/ |
| ° C. | h | Gas | bar | (C₁-C₃) | (C₄-C₁₂) | (C₁₃-C₂₀) | C₂₀₊ | % |
| 280 | 1 | H₂ | 50 | 3.8 | 70.6 | 1.5 | 24.1 | 111.6 |
| 310 | 1 | H₂ | 50 | 7.5 | 90.4 | 1.0 | 1.2 | 108.7 |
| 340 | 1 | H₂ | 50 | 9.6 | 85.7 | 0.55 | 4.2 | 122.9 |
| 370 | 1 | H₂ | 50 | 17.8 | 82.0 | 0.27 | 0 | 120.3 |
| 400 | 1 | H₂ | 50 | 17.4 | 82.6 | 0 | 0 | 118.7 |
| 430 | 1 | H₂ | 50 | 47.4 | 52.6 | 0 | 0 | 121.4 |

FIGS. 2A-2C show the mass balance of various components contained in the product resulted from the liquefaction reaction of HDPE feedstock in the presence of the NiMo/H—USY catalysts. As shown in these figures, by changing the acidity of the catalyst, the product distribution of various components varied. At similar reaction conditions, an increase in the reaction temperature increased the gaseous (C₁-C₃) product yield. At similar reaction conditions, the naphtha (C₄-C₁₂) product yield peaked at 340° C., and an increase in the reaction temperature from 340° C. to 430° C. did not in general further increase the naphtha product yield. The reaction in the presence of a low-acidity catalyst (NiMo/H—USY-60) produced a product with the highest percentage of naphtha, at 340° C. (higher than 95%).

These results show that the product composition, e.g., the naphtha product yield, from the liquefaction reaction of HDPE feedstock can be controlled by changing the nature of the catalyst as well as the reaction temperature. The results also indicate that when using the proper hydrocracking catalyst, such as NiMo/H—USY catalyst, the liquefaction reaction of HDPE feedstock can be carried out at a much milder reaction temperature (e.g., 300-340° C.), with a naphtha product yield even higher than a much severer reaction temperature (e.g., 430° C.).

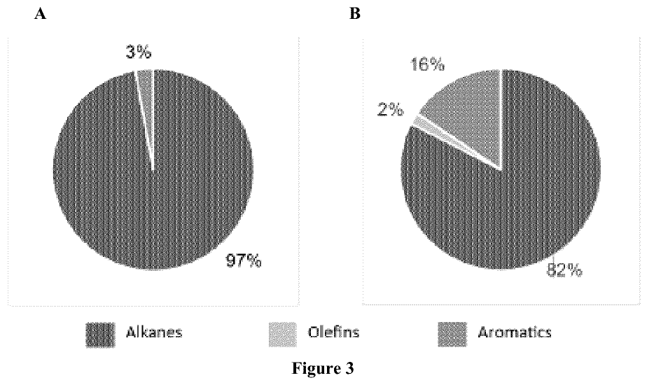

FIG. 3A shows the composition of the naphtha product obtained from the one-step liquefaction reaction of HDPE feedstock using the hydrocracking catalyst as described herein (see NiMo/H—USY-30 in Table 8 below). As shown in the figure, this naphtha product does not contain unsaturated alkenes, and is comprised of mostly saturated hydrocarbon (alkanes) with a small amount of aromatics, which is ideal for a naphtha cracker. Whereas the naphtha currently used in a commercial refinery, as shown in FIG. 3B, can have a relatively higher percentage of aromatics, with some amounts of olefins. These results show that the one-step plastic liquefaction reaction described herein can make a high-quality naphtha product, having a much higher quality than the naphtha obtained from crude oil typically used in a commercial refinery.

In addition, two sets of comparative examples were performed:
the reaction of HDPE (400 mg) in the presence of NiMo/HUSY-60 catalyst (100 mg) (without H₂ under He) (He control), with reaction conditions shown in Table 2 (He bolded); and
the reactions of HDPE (400 mg) in the presence of the HUSY-60 support (100 mg) (with no NiMo metal in the catalyst) (under H₂ or under He), with reaction conditions shown in Table 5.

TABLE 5
Product yields resulted from HDPE (400 mg) liquefaction using
HUSY-60 support (SiO₂/Al₂O₃ = 60), without NiMo metal (100 mg)

| Reaction conditions | | | | Product composition/% | | | | Mass |
|---|---|---|---|---|---|---|---|---|
| Temperature/ | Time/ | | | Gas | Naphtha | Kerosene | Solids | balance/ |
| ° C. | h | Gas | Pressure/ | (C₁-C₃) | (C₄-C₁₂) | (C₁₃-C₂₀) | C₂₀₊ | % |
| 340 | 1 | H₂ | 50 | 0.81 | 31.0 | 2.7 | 65.4 | 103.0 |
| 340 | 1 | He | 50 | 0.71 | 27.5 | 2.3 | 69.4 | 98.1 |

Table 2 contains the results for a comparative example in which H₂ was not introduced into the reactor. As shown in this comparative example, the naphtha composition in the reaction product resulted from the reactions without H₂ and under He decreased significantly compared to the working example under the same reaction conditions (340° C.) but with H₂. These results indicate that H₂ is essential for the catalytic cracking of HDPE at low reaction temperatures.

Table 5 contains the results for comparative examples in which the catalyst used was a HUSY-60 support, with no NiMo metal. The comparative examples were conducted under two different conditions: in the presence of H₂, and in the absence of H₂ but under He. Compared to the products resulted using the NiMo/HUSY catalysts at the same temperature (340° C.) in Tables 2, 3, and 4, the naphtha composition in the reaction product of these comparative examples resulted from the reactions without NiMo metal decreased significantly. These two comparative examples (whether under H₂ or under He), however, produced similar product compositions. These results indicates that without the NiMo metal site, H₂ did not appear to have participated in the reaction at the given reaction conditions.

### Example D—Treating HDPE feedstock with NiMo/γ-Al₂O₃catalyst (weakly acidic support)

About 400 mg of HDPE and 800 mg of NiMo/γ-Al₂O₃ catalyst were loaded inside a microbomb batch reactor. The reactor was purged with He several times before pressurizing with H₂ to 700 psi. The reactor was immersed in a fluidized sand bath held at 440° C. for 2 hours. Two control reactions were performed with otherwise identical reaction conditions, except the following conditions: the reaction of HDPE (400 mg) in the presence of the weakly acidic support γ-Al₂O₃ (800 mg) (with no NiMo metal in the catalyst) (acid cracking control); and the pyrolysis reaction of HDPE (400 mg), without a catalyst (thermal pyrolysis control). These control reactions were used as a benchmark to show the effect of NiMo active sites.

After each experiment, quantitative and qualitative analysis of the products (and specific product stream, such as naphtha stream) were performed via GC and GC-MS. The yield of various components contained in the product and composition % were analyzed with an Agilent 8890 GC instrument, using Supelco Petrocol DH (100 m×250 μm×0.5 μm) and DB-1 column (30 m×320 μm×1 μm). The product quality (compositional analysis) of the naphtha product stream was analyzed with a Gerstel GC-MS instrument, using PoraBOND (100 m×250 μm×0.5 μm), DB-1 (30 m×320 μm×1 μm) and GS-GasPro (30 m×320 μm×0 μm) column.

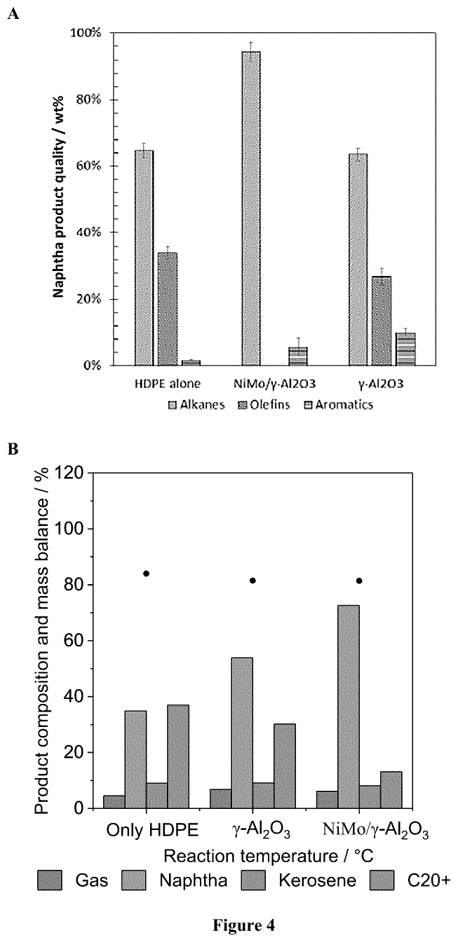

The results of product compositions and mass balance of various components contained in the reaction product using the above reaction conditions are shown in Tables 6-7 and plotted in FIGS. 4A-4B.

TABLE 6
Product yields resulted from HDPE (400 mg) liquefaction
using NiMo/γ-Al₂O₃ catalyst (800 mg)

| Reaction conditions | | | | Product composition/% | | | | Mass |
|---|---|---|---|---|---|---|---|---|
| Temperature/ | Time/ | | Pressure/ | Gas | Naphtha | Kerosene | Solids | balance/ |
| ° C. | hour | Gas | bar | (C₁-C₃) | (C₄-C₁₂) | (C₁₃-C₂₀) | C₂₀₊ | % |
| 440 | 2 | H₂ | 50 | 6.1 | 72.6 | 8.1 | 13.1 | 81.4 |

TABLE 7
Product yields resulted from HDPE (400 mg) liquefaction
using γ-Al₂O₃ support, without NiMo metal (800 mg)

| Reaction conditions | | | | Product composition/% | | | | Mass |
|---|---|---|---|---|---|---|---|---|
| Temperature/ | Time/ | | Pressure/ | Gas | Naphtha | Kerosene | Solids | balance/ |
| ° C. | hour | Gas | bar | (C₁-C₃) | (C₄-C₁₂) | (C₁₃-C₂₀) | C₂₀₊ | % |
| 440 | 2 | H₂ | 50 | 6.8 | 53.9 | 9.1 | 30.2 | 81.5 |

As shown in FIG. 4A, under the same reaction conditions, compared to the two control experiments, the liquefaction of HDPE using the NiMo/γ-Al₂O₃catalyst did not yield a detectable fraction of olefins (unsaturated hydrocarbons). The product resulted from the liquefaction of HDPE using the NiMo/γ-Al₂O₃ catalyst consisted of mostly linear and branched alkanes, balanced by a low quantity of aromatics. In contrast, the two control experiments, the acid cracking of HDPE (with weakly acidic support γ-Al₂O₃) and the HDPE pyrolysis (with no catalyst), resulted in products containing significant amounts of olefins (unsaturated hydrocarbons). These products resulted from the control experiments also contained aromatics in amounts much higher than the products resulted from the liquefaction of HDPE using the NiMo/γ-Al₂O₃ catalyst.

As shown in FIG. 4B, under the same reaction conditions, the liquid product (C₄-C₂₀) yield increased significantly in the product resulted from the liquefaction of HDPE using the NiMo/γ-Al₂O₃ catalyst, compared to the products resulted from the acid cracking control experiment (with weakly acidic support γ-Al₂O₃) and the thermal pyrolysis control experiment (with no catalyst).

In sum, the results indicate that the use of one-step, direct hydrocracking of polymer feedstocks, in the presence of hydrocracking catalyst described herein, such as NiMo/γ-Al₂O₃ catalyst, successfully produced a product having a high degree of saturated hydrocarbons and an enhancement in the liquid product yield. These results also show successful conversion of plastics to high quality naphtha product via the novel one-step process described herein (without employing a conventional pyrolysis step).

Specific product stream, such as naphtha stream, was analyzed for certain examples from Examples C and D, including working examples and comparative examples, using GC-MS. The results of the composition of the naphtha product stream (C₄-C₁₂) from these examples are shown in Table 8.

TABLE 8
Product composition of the naphtha product stream (C₄-C₁₂) using GC-MS.

| | Reaction conditions | | | | | | |
|---|---|---|---|---|---|---|---|
| | Temperature/ | Time/ | | H₂ Pressure/ | Product composition/% | | |
| Catalyst/Support | ° C. | hour | Gas | bar | Alkanes | Alkenes | Aromatics |
| NiMo/H-USY-60 | 340 | 1 | H₂ | 50 | 98 | 0 | 2 |
| NiMo/H-USY-60 | 340 | 1 | He | 50 | 92 | 2 | 6 |
| (comparative) | | | | | | | |
| NiMo/H-USY-30 | 340 | 1 | H₂ | 50 | 97 | 0 | 3 |
| H-USY-60 | 340 | 1 | H₂ | 50 | 82 | 0.5 | 17.5 |
| (comparative) | | | | | | | |
| H-USY-60 | 340 | 1 | He | 50 | 83 | 1 | 16 |
| (comparative) | | | | | | | |
| NiMo/γ-Al₂O₃ | 440 | 2 | H₂ | 50 | 95 | 0 | 5 |
| γ-Al₂O₃ | 440 | 2 | H₂ | 50 | 64 | 12 | 24 |
| (comparative) | | | | | | | |

As shown in Table 8, compared to each comparative experiment under the same reaction conditions, the liquefaction of HDPE using the hydrocracking catalyst described herein (e.g., NiMo/H—USY-60 or NiMo/γ-Al₂O₃ catalyst) with H₂ did not yield a detectable fraction of olefins (unsaturated hydrocarbons). The product resulted from the liquefaction of HDPE using the NiMo/γ-Al₂O₃ catalyst consisted of mostly linear and branched alkanes, balanced by a low quantity of aromatics. In contrast, the comparative experiments, by using the support γ-Al₂O₃ and no NiMo metal, or by a reaction under He without H₂, resulted in products containing significant amounts of olefins (unsaturated hydrocarbons) and contained aromatics in amounts much higher than the products resulted from the liquefaction of HDPE using the hydrocracking catalyst described herein.

### Example E—Treating HDPE Feedstock with NiMo/H—USY Catalyst Varying Hydrogen Partial Pressure (P_{hydrogen}) at Constant Total Pressure (Pₜₒₜₐₗ)

Experiments were conducted by loading virgin HDPE (400 mg) and NiMo/H—USY catalyst (75 mg) in a batch reactor. The H—USY support with SiO₂/Al₂O₃ ratio at 60 was used to synthesize the NiMo/H—USY catalyst. The NiMo-supported catalysts were synthesized using the sequential wetness impregnation method. Before synthesis, the H—USY zeolite (Zeolyst International) catalyst support was calcined at 550° C. for 4 hours under air. Prior to synthesis, the nickel nitrate and ammonium heptamolybdate metal precursors were dissolved separately in deionized water to make an aqueous solution, based on the desired Ni to Mo weight ratio (0.25) and a final concentration of Mo of 10% wt (and 2.5% wt. of Ni) in the resulting catalyst. The molybdenum precursor solution was impregnated into the calcined support, followed by overnight drying at 110° C. After drying, the nickel precursor solution was impregnated, followed by overnight drying at 110° C. and calcination at 550° C. for 4 hours under air. For activity testing, the catalyst was reduced under the flow of hydrogen at 450° C. for 4 hours.

The reactor was purged with He several times before pressurizing with He and H₂ to a total pressure 50 bar. The partial pressures of H₂ and He were different for each run, according to Table 9. The reactor was immersed in a fluidized sand bath and the reaction was carried out at a reaction temperature of 340° C., for 1 hour.

In this example, the yield of various components contained in the product and composition % were analyzed with an Agilent 8890 GC instrument, using Supelco Petrocol DH (100 m×250 μm×0.5 μm) and DB-1 column (30 m×320 μm×1 μm). The product quality (compositional analysis) of the naphtha product stream was analyzed with a Gerstel GC-MS instrument, using PoraBOND (100 m×250 μm×0.5 μm), DB-1 (30 m×320 μm×1 μm) and GS-GasPro (30 m×320 μm×0 μm) column.

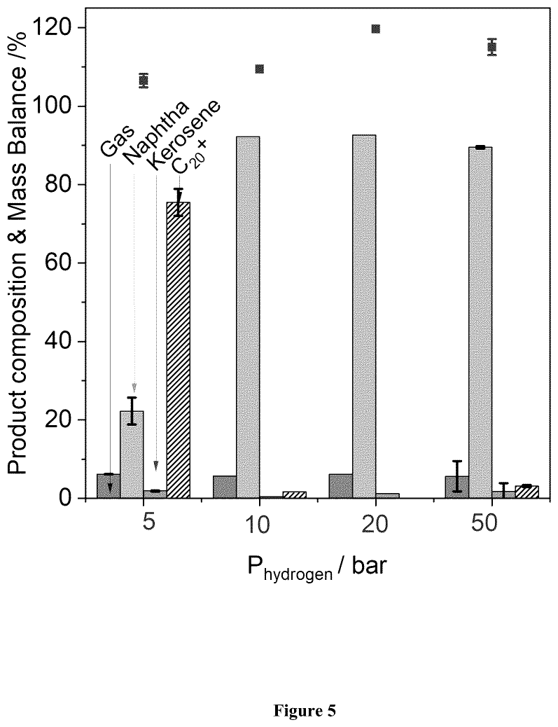

The results of product compositions and mass balance of various components contained in the reaction product using the above reaction conditions are shown in Table 9 and plotted in FIG. 5.

TABLE 9
Product yields resulted from HDPE (400 mg) liquefaction using NiMo/H-USY catalyst varying
hydrogen partial pressure (Phydrogen) at constant total pressure (Ptotal) of 50 bar

| Reaction Conditions | | | | | | | | |
|---|---|---|---|---|---|---|---|---|
| Catalyst/Support | | H₂ | He | Product composition/% | | | | Mass |
| Temperature/° C. | | pressure/ | pressure/ | Gas | Naphtha | Kerosene | Solids/ | balance/ |
| Time/hour | Gas | bar | bar | (C1-C3) | (C4-C12) | (C13-C20) | C20+ | % |
| NiMo/H-USY-60 | H2/He | 5 | 45 | 6% | 22% | 2% | 75% | 106% |
| 340° C. | H2/He | 10 | 40 | 6% | 92% | 0% | 2% | 109% |
| 1 hour | H2/He | 20 | 30 | 6% | 93% | 1% | 0% | 120% |
| | H2/He | 50 | 0 | 6% | 89% | 2% | 3% | 115% |

These results show that the naphtha yield decreased at low hydrogen partial pressure, indicating coke formation at low hydrogen pressure. The naphtha yield remained almost similar above 10 bar of hydrogen partial pressure, suggesting low coke formation at high hydrogen pressures. Hence high hydrogen pressures are desirable to mitigate coke formation.

### Example F—Treating HDPE feedstock with NiMo/H—USY catalyst varying reactor pressure

Experiments were conducted by loading virgin HDPE (400 mg) and NiMo/H—USY catalyst (75 mg) in a batch reactor. The H—USY support with SiO₂/Al₂O₃ ratio at 60 was used to synthesize the NiMo/H—USY catalyst. The NiMo-supported catalysts were synthesized using the sequential wetness impregnation method. Before synthesis, the H—USY zeolite (Zeolyst International) catalyst support was calcined at 550° C. for 4 hours under air. Prior to synthesis, the nickel nitrate and ammonium heptamolybdate metal precursors were dissolved separately in deionized water to make an aqueous solution, based on the desired Ni to Mo weight ratio (0.25) and a final concentration of Mo of 10% wt (and 2.5% wt. of Ni) in the resulting catalyst. The molybdenum precursor solution was impregnated into the calcined support, followed by overnight drying at 110° C. After drying, the nickel precursor solution was impregnated, followed by overnight drying at 110° C. and calcination at 550° C. for 4 hours under air. For activity testing, the catalyst was reduced under the flow of hydrogen at 450° C. for 4 hours.

The reactor was purged with He several times before pressurizing with H₂ to a total pressures of 10, 20, 30 and 50 bar (P_{hydrogen}=Pₜₒₜₐₗ)-the pressures of H₂ were different for each run, according to Table 10. The reactor was immersed in a fluidized sand bath and the reaction was carried out at a reaction temperature of 350° C., for 1 hour.

In this example, the yield of various components contained in the product and composition % were analyzed with an Agilent 8890 GC instrument, using Supelco Petrocol DH (100 m×250 μm×0.5 μm) and DB-1 column (30 m×320 μm×1 μm). The product quality (compositional analysis) of the naphtha product stream was analyzed with a Gerstel GC-MS instrument, using PoraBOND (100 m×250 μm×0.5 μm), DB-1 (30 m×320 μm×1 μm) and GS-GasPro (30 m×320 μm×0 μm) column.

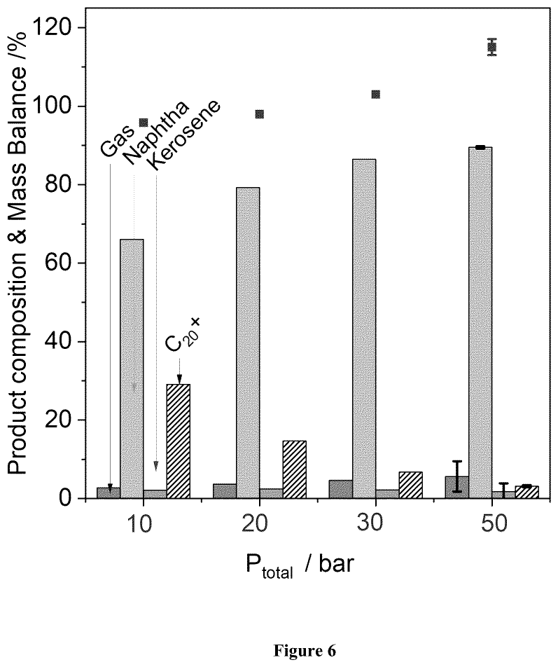

The results of product compositions and mass balance of various components contained in the reaction product using the above reaction conditions are shown in Table 10 and plotted in FIG. 6.

TABLE 10
Product yields resulted from HDPE (400 mg) liquefaction using
NiMo/H-USY catalyst varying total pressure (Ptotal = Phydrogen)

| Reaction Conditions | | | | | | | |
|---|---|---|---|---|---|---|---|
| Catalyst/Support | | H2 | Product composition/% | | | | Mass |
| Temperature/° C. | | pressure/ | Gas | Naphtha | Kerosene | Solids/ | balance/ |
| Time/hour | Gas | bar | (C1-C3) | (C4-C12) | (C13-C20) | C20+ | % |
| NiMo/H-USY-60 | H2 | 10 | 3% | 66% | 2% | 29% | 96% |
| 350° C. | H2 | 20 | 4% | 79% | 2% | 15% | 98% |
| 1 hour | H2 | 30 | 5% | 86% | 2% | 7% | 103% |
| | H2 | 50 | 6% | 89% | 2% | 3% | 115% |

With the decrease in total reactor pressure, the naphtha yield decreased, suggesting that higher reactor pressures may increase the hydrocracking rates.

What is claimed:

1. A process for chemically treating a carbon-containing feedstock, the process comprising:
contacting the carbon-containing feedstock and a hydrogen stream in the presence of at least one hydrocracking catalyst to produce an alkane-containing product stream;
wherein the hydrocracking catalyst comprises at least one transition metal or transition metal sulfide supported on an oxide-containing support.

2. The method of claim 1, wherein the contacting step is a reacting step.

3. A process for depolymerizing a polymer-based feedstock, comprising:
reacting a polymer-based feedstock with a hydrogen stream in the presence of a hydrocracking catalyst, in a one-step, hydrocracking reaction, to depolymerize the polymer-based feedstock and form an alkane-containing product stream,
wherein the hydrocracking catalyst comprises at least one transition metal or transition metal sulfide supported on an oxide-containing support.

4. The process of claim 1, wherein the process is a one-pot process.

5. The process of claim 1, wherein the process does not involve pyrolysis of the polymer-based feedstock.

6. The process of claim 1, wherein the metal of the at least one transition metal or transition metal sulfide is a Group VI to Group X metal.

7. The process of claim 6, wherein the metal is selected from the group consisting of Mo, W, Fe, Co, Ir, Ni, Pd, Pt, and combinations thereof.

8. The process of claim 1, wherein the catalyst comprises two or more transition metals, transition metal sulfides, and combinations thereof, supported on the oxide-containing support.

9. The process of claim 1, wherein the at least one transition metal or transition metal sulfide is Pt, Pd, Ir, Ni, Co, NiMo, CoMo, NiW, NiMoSx, NiWS, or FeSx.

10. The process of claim 1, wherein the oxide-containing support comprises aluminum oxide, silicon oxide, aluminosilicate, or combinations thereof.

11. The process of claim 10, wherein the oxide-containing support comprises aluminosilicates in the form of zeolites.

12. The process of claim 1, wherein the carbon-containing feedstock is a polymer-based feedstock.

13. The process of claim 12, wherein the polymer-based feedstock is a petroleum-based virgin resin, bio-based resin, recycled resin, or combinations thereof.

14. The process of claim 13, wherein the polymer-based feedstock is a post-consumer resin (PCR) or a post-industrial resin (PIR).

15. The process of claim 2, wherein the reaction is carried out at a temperature ranging from 200 to 500° C., preferably from 300 to 450° C.

16. The process of claim 15, wherein the reaction is carried out at a hydrogen pressure ranging from 1 to 200 bar, preferably from 5 to 100 bar.

17. The process of claim 1, wherein the alkane-containing product stream comprises C₁-C₂₀ hydrocarbons, preferably C₁-C₂₀ alkanes.

18. The process of claim 1, further comprising the step of pre-mixing the carbon-containing feedstock or the polymer-based feedstock with a solvent medium, prior to the contacting or reacting step.

19. The process of claim 18, wherein the solvent medium comprises a liquid product stream, preferably C₄-C₂₀ hydrocarbons, obtained from the depolymerization reaction.

20. An alkane-containing mixture obtained by the process of claim 1.

21. The mixture of claim 20, wherein the mixture comprises at least 50% by weight of C₄-C₁₂ hydrocarbons, preferably C₄-C₁₂ alkanes, based on the total weight of the mixture.

22. A system for chemically treating a carbon-containing feedstock, the system comprising:
a reactor receiving the carbon-containing feedstock, a hydrogen stream and at least one hydrocracking catalyst, wherein the reactor is configured to convert the carbon-containing feedstock into an alkane-containing product stream,
wherein the hydrocracking catalyst comprises at least one transition metal or transition metal sulfide supported on an oxide-containing support.

23. The system according to claim 22, wherein the system has a single reactor.

24. The system according to claim 22, wherein the system does not include a pyrolysis unit.

25. A method for controlling an alkane carbon chain distribution of a product stream obtained from depolymerizing a polymer-based feedstock, the method comprising the steps of:
selecting a molar ratio between aluminum oxide and silicon oxide of a catalytic support comprising a mixture of aluminum oxide and silicon oxide;
providing a catalyst comprising at least one transition metal or transition metal sulfide supported on the catalytic support having the selected molar ratio between aluminum oxide and silicon oxide;
selecting a temperature in the range of 200 to 500° C. to carry out the depolymerization reaction; and
reacting the polymer-based feedstock and a hydrogen stream in the presence of the catalyst at the selected temperature to generate an alkane-containing product stream, having controlled alkane carbon chain distribution.

26. A method for selectively converting a polymer-based feedstock to a liquid naphtha or naphtha-like product, comprising:
reacting a polymer-based feedstock with a hydrogen stream in the presence of a hydrocracking catalyst, in a one-step, hydrocracking reaction, to depolymerize the polymer-based feedstock and form a liquid naphtha or naphtha-like product containing at least 50% by weight of C₄-C₁₂ hydrocarbons and no more than 5% by weight of unsaturated hydrocarbons, based on the total weight of the product,
wherein:
the hydrocracking catalyst comprises at least one transition metal or transition metal sulfide supported on a catalytic support comprising an aluminum oxide or a mixture of silicon oxide and aluminum oxide at a molar ratio ranging from 5 to 80, and
the reaction temperature ranges from about 300-450° C. and hydrogen pressure ranges from about 5 to 100 bar.
